(19) United States
(12) Patent Application Publication
(10) Pub. No.: US 2003/0124233 A1
(43) Pub. Date: Jul. 3, 2003

(54) Use of insoluble highly crosslinked popcorn polymers as filter aids and/or stabilizers

(76) Inventors: Marcos Gomez, Heidelberg (DE); Helmut Meffert, Mannheim (DE); Elisa Hamn de Bantleon, Munchen (DE); Jurgen Ziehl, Limburgerhof (DE); Barbara Lebtig, Ilsfeld (DE); Klemens Mathauer, Heidelberg (DE); Izaskun Manteca Zuazo, Ludwigshafen (DE)

Correspondence Address: Herbert B. Keil, KEIL & WEINKAUF, 1350 Connecticut Ave., N.W., Washington, DC, 22036, US

(21) Appl. No.: 10/309,057

(22) Filed: Dec. 4, 2002

(30) Foreign Application Priority Data
Dec. 7, 2001 (DE) 10160140.9

(51) Int. Cl. C12H 1/04

(52) U.S. Cl. 426/422

(57) ABSTRACT

The use of polystyrene-containing popcorn polymers as filter aid and/or stabilizer for filtering or stabilizing aqueous liquids, a process for filtration or stabilization, and novel only slightly swellable popcorn polymers are described.

The present invention relates to the use of polystyrene-containing popcorn polymers as filter aids and/or stabilizers for filtering or stabilizing aqueous liquids, a process for filtration and/or stabilization, and also novel, only slightly swellable popcorn polymers.

Separating polyphenols or proteins, which can bind complexes, via precipitation or filtration is an important process step in many beverage production processes, because removal of these substances leads to longer shelf life.

Frequently, stabilization is first performed by separating off haze-causing substances, such as polyphenols or proteins, by filtration. Stabilization can be performed by binding or precipitating out the substances reducing shelf life. For example, silica gel binds or precipitates proteins and polyvinylpyrrolidone binds phenols.

Filter aids and stabilizers have long been used separately or together. When the respective substance is used alone, this is expensive in terms of equipment, and when used together, disposal is frequently a problem.

The term filter aids is taken to mean a number of products which are used in bulk, pulverulent, granulated or fibrous form as precoat material in filtration.

Filter aids can be applied to the filter medium as a filter aid layer (precoat filter) before starting filtration, in order to achieve a looser cake build up, or can be added continuously to the prefilt.

Known filtration additives are, for example, diatomaceous earths, natural products which originate from the calcination of diatomite. The main constituents are amorphous SiO₂ modifications, accompanied by oxides of aluminum, iron and other elements, and also silicate compounds thereof. Perlites are ignited ground selected expanded clays of volcanic origin (Rhyolite). The structure is lamellar and may be described chemically as a sodium silicate, potassium silicate, aluminosilicate. Bentonites are clay minerals having high swellability and high absorption capacity.

Filter aids should form a porous environment during filtration which absorbs the impurities to be removed and facilitates the outflow of the liquid phase.

The additives should have an increased porosity and should also not deform under the effect of pressure. In addition, the substances should be chemically inert and easily recoverable.

For filtering beer, currently, predominantly kieselguhr precoat filters and sheet filters are used. In precoat filtration, before the start of filtration, a kieselguhr preliminary layer is precoated onto a support surface (filter screen). After precoating this preliminary layer, a mixture of fine and coarse kieselguhr is added to the beer to be filtered (prefilt). In the production of beer, a kieselguhr consumption of from 150 to 200 g/hl of beer must be expected. Kieselguhr has proven itself for precoat filtration, particularly because of its large pore volume, its low bulk density, its relatively high absorption capacity and its high specific surface area.

A disadvantage of the use of kieselguhr is that it is spent in activity after a number of filter operation hours due to retained solids material, and must be removed from the filter support surfaces and replaced.

Land-filling spent kieselguhr, because of legal stipulations, is only possible with great difficulty and at great expense. Attempts to regenerate kieselguhr which is unusable as filter material have not been able to be carried out in practice. In addition, kieselguhr has been under discussion for some time because of possible carcinogenic activity.

WO 98/40149 describes the use of finely divided particles of plant fibers as filter aids. These filter aids comprise wood particles, wood fibers and wood comminution residues. Before use, the particles must be subjected to treatment with dilute acid and/or alkali metal hydroxide solution.

WO 96/35497 discloses regenerable filter aids for filtering aqueous media, in particular beer, consisting of polyamides, polyvinylchloride, polypropylene, polystyrene or polycaprolactam.

EP 483 099 describes a process for beer filtration using filter aids which consist of spheroidal particles of a particle size from 5 to 50 μm.

EP 351 361 describes highly crosslinked polyvinylpyrrolidones (PVPP) as stabilizers and filter aids.

WO 00/68286 discloses styrene-containing popcorn polymers having a styrene content greater than 50% by weight.

The removal of beverage constituents which cause haze or affect stability, for example the removal of polyphenols from beer, is closely connected with flavor quality. Targeted adjustment of the absorption of polyphenols is, however, only possible with great difficulty using the prior art filter aids or stabilizers.

It is an object of the present invention, therefore, to provide a filter aid and/or stabilizer for beverage production which is firstly simple to regenerate and which makes it possible to influence in a targeted manner the absorption of haze-causing substances or substances impairing stability.

We have found that this object is achieved, surprisingly, by the inventive popcorn polymers.

The invention relates to insoluble, only slightly swellable popcorn polymers containing

a) from 0.1 to 99% by weight of an N-vinyllactam or N-vinylamine

b) from 0 to 10% by weight of a bifunctional crosslinker component

c) from 0.1 to 50% by weight of at least one further monomer polymerizable by free-radicals

where the percentages by weight of the individual components are based on the total amount of the popcorn polymer and total 100%.

The name popcorn polymers represents foamed, crusty polymer grains having a cauliflower-like structure. Because of their generally highly crosslinked structure, popcorn polymers are generally insoluble and virtually not swellable.

Popcorn polymers are used, for example, for absorbing tannins from beverages and as ion exchangers. Carboxyl-containing popcorn polymers can also be obtained by saponifying polymers containing acrylic ester and acrylamide units.

Ullmanns Encyklopädia der Tech. Chemie [Ullmanns Encyclopedia of Industrial Chemistry], 4^{th} Edition, Volume 19, page 385 (1980) discloses that, on heating N-vinylpyrrolidone with hydroxides and alkoxides of alkali metals and alkaline earth metals, an insoluble polymer which is only slightly swellable in water is formed in spontaneous reaction. Such substances termed popcorn polymers are also formed on heating N-vinylpyrrolidone with divinyl compounds in the absence of oxygen.

Hydrophilic components a) generally means N-vinyllactams or N-vinylamines. Those which are preferred here are the following polymerizable comonomers: N-vinyllactams and N-vinylamines, in particular N-vinylpyrrolidone, N-vinylpiperidone, N-vinylcaprolactam, N-vinylimidazole, N-vinyl-2-methylimidazole, N-vinyl-4-methylimidazole and N-vinylformamide.

Preferred hydrophilic components are N-vinylpyrrolidone, N-vinylimidazole and N-vinylcaprolactam, particularly preferably N-vinylpyrrolidone.

The monomers a) are used in the context of the invention in amounts of from 0.1 to 99% by weight, preferably greater than 50% by weight, based on the total amount of the polymer.

The monomers b) in general mean compounds which contain at least 2 ethylenically unsaturated non-conjugated double bonds in the molecule and thus act as bifunctional crosslinkers during polymerization. Preferred representatives of monomers c) are, for example, alkylenebisacrylamides, such as methylenebisacrylamide and N,N′-acryloylethylenediamine, N,N′-divinylethyleneurea, N,N′-divinylpropyleneurea, ethylidene-bis-3-(N-vinylpyrrolidone), N,N′-divinyldiimidazolyl-(2,2′)butane and 1,1′-bis-(3,3′-vinylbenzimidazolid-2-one)-1,4-butane. Other suitable crosslinkers are, for example, alkylene glycol di(meth)acrylates such as ethylene glycol diacrylate, ethylene glycol dimethacrylate, tetraethylene glycol acrylate, tetraethylene glycol dimethacrylate, diethylene glycol acrylate, diethylene glycol methacrylate, aromatic divinyl compounds such as divinylbenzene and divinyltoluene, and also vinyl acrylate, allyl acrylate, allyl methacrylate, divinyldioxane, pentaerythritol triallyl ether, and mixtures of the crosslinkers.

Particularly preferred crosslinkers are N,N′-divinylethyleneurea and divinylbenzene.

The crosslinkers are used if appropriate in amounts of from 0 to 10% by weight, preferably from 0.1 to 8% by weight, particularly preferably in amounts of from 0.2 to 5% by weight, based on the total amount of polymer.

Monomers c) generally mean compounds which are capable of undergoing free-radical polymerization. Representatives of monomers c) are, for example, monoolefins or biolefins, such as propylene, ethylene, isobutylene, methylbut-1-ene, methylpent-1-ene, isoprene, butadiene, hexadiene, dicyclopentadiene, ethylidene, norbornene, styrene or unsaturated styrene derivatives, for example sulfone-containing styrenes, for example styrene-3-sulfonic acid or sodium styrene-3-sulfonate, styrene-4sulfonic acid or sodium styrene-4-sulfonate and amino-containing styrenes. Amino-containing styrenes are, for example, styrenes which bear the following substituents at the 3 position:

—CH₂N³⁰(CH₃)₃Cl⁻, —CH₂N⁺(CH₃)₂CH₂CH₂OHCl⁻, —CH₂N(CH₃)₂, CH₂NHCH₃, CH₂NH₂. Other monomers are halogenated vinyl monomers, for example vinyl chloride, vinyl fluoride, chloroprene or vinylidene chloride. Monomer derivatives of α,β-unsaturated acids such as acrylate esters, methacrylate esters, such as acrylamides and acrylonitrile, are also included. Examples of these esters are, specifically, methyl acrylate, methyl methacrylate, ethyl acrylate, ethyl methacrylate, n-propyl acrylate, n-propyl methacrylate, isopropyl acrylate, isopropyl methacrylate, lauryl acrylate, lauryl methacrylate, stearyl acrylate, stearyl methacrylate and the esters of acrylic acid and methacrylic acid derived from the isomeric butanols, and hydroxyethyl acrylate, hydroxyethyl methacrylate, hydroxymethyl methacrylate, hydroxypropyl acrylate, hydroxypropyl methacrylate, hydroxybutyl acrylate, hydroxybutyl methacrylate. Other suitable monomers are, for example, unsaturated alcohols and amines and derivatives thereof, for example vinyl alcohol, vinyl acetate, vinyl propionate, vinyl stearate, vinyl benzoate, vinyl maleate, vinyl butyrate, allyl phthalate, allylmelamine; αβ-unsaturated acids such as acrylic acid and methacrylic acid can be either neutralized or not neutralized. Monomer derivatives of α,β-unsaturated acids such as acrylate esters, methacrylate esters, acrylamides and acrylonitrile are also included. Examples of these esters are, specifically, methyl acrylate, methyl methacrylate, ethyl acrylate, ethyl methacrylate, n-propyl acrylate, n-propyl methacrylate, isopropyl acrylate, isopropyl methacrylate, lauryl acrylate, lauryl methacrylate, stearyl acrylate, stearyl methacrylate, and the esters of acrylic acid and methacrylic acid which are derived from the isomeric butanols, and also hydroxyethyl acrylate, hydroxyethyl methacrylate, hydroxymethyl methacrylate, hydroxypropyl acrylate, hydroxypropyl methacrylate, hydroxybutyl acrylate, hydroxybutyl methacrylate. Other monomers are acrylamides and methacrylamides. Preferably, styrenes, acrylic acid and methacrylic acid are used, in particular, preferably, styrenes are used.

The monomers c) are used in the context of the invention in amounts of from 0.1 to 50% by weight, preferably from 20 to 50% by weight, based on the total amount of polymer.

The popcorn polymerization is carried out by known processes, for example as precipitation polymerization or by bulk polymerization. Preference is given to a procedure in which, as described in EP-A-0 177 812, the popcorn polymerization is started by heating a mixture of from 99.6 to 98.8% by weight of N-vinylpyrrolidone and from 0.4 to 1.2% by weight of a compound having at least two ethylenically unsaturated double bonds as crosslinker to a temperature of from 60 to 150° C. in the absence of oxygen and polymerization initiators. This polymerization is initiated in particular by the presence of small amounts of sodium hydroxide solution or potassium hydroxide solution. Within a short time a polymerizable popcorn polymer forms which, on addition of the remaining monomer mixture, that is to say in particular the monomer styrene and the remaining amount of the monomers c), starts the popcorn polymerization of these monomers without any induction period. In addition, it is possible to transfer the polymerizable popcorn polymer to a vessel which contains monomer and crosslinker, or into which the monomer and crosslinker are then added.

The popcorn polymerization can also be carried out without solvents. In this case the monomer mixture of a), b) and c) is rendered inert by introducing nitrogen, and is then heated to a temperature in the range from 20 to 200° C., preferably from 100 to 200° C., particularly preferably from 150 to 180° C. It is advantageous to continue to pass a gentle stream of nitrogen through the monomers even during the polymerization.

Oxygen is also excluded by polymerizing the batch at a pressure which is below atmospheric pressure and at which the monomers boil. Depending on the type of monomers used and on the temperature selected, the mixture polymerizes within from 1 to 20 hours. For example, in the polymerization of N-vinylamides with 2% N,N′-divinylethyleneurea at 150° C. with stirring using a powerful agitator and at a pressure of 310 mbar, the first polymer particles form after 2.5 hours, the amount of which slowly increases until after approximately 10 hours at polymerization time the reaction mixture consists of a powder. The popcorn polymer is obtained therefrom in yields of greater than 90% in the form of a powder having a mean particle size of from about 10 μm to 5 mm, preferably from 10 μm to 500 μm.

For preparation of the popcorn polymers, precipitation polymerization in water is preferred. The concentration of the monomers is expediently chosen here so that the reaction mixture can readily be stirred over the entire reaction time. If the concentration of the monomers in water is too high, for example 95%, the polymer grains frequently become sticky, so that stirring becomes more difficult than in the absence of water. In order to carry out the reaction in conventional stirred tanks, monomer concentrations of from about 5 to 30, preferably from 10 to 20, % by weight are chosen, based on the aqueous mixture. If more powerful agitators are available, the monomer concentration of the aqueous solution can be increased even to 50% by weight, if appropriate even above this.

Oxygen may best be excluded by heating the mixture to be polymerized to boiling and, if appropriate, additionally employing an inert gas atmosphere by passing nitrogen, for example, through the reaction mixture. The polymerization temperatures can be varied within a broad range, for example from about 20 to 200° C., preferably from 50 to 150° C.

In some cases it can also be advantageous, for complete removal of dissolved oxygen, to add small amounts, from 0.1 to 1% by weight, based on monomer, of a reducing agent such as sodium sulfite, sodium pyrosulfite, sodium dithionite, ascorbic acid or mixtures of the reducing agents.

In a particularly preferred embodiment of the polymerization, the comonomer c), a portion of the crosslinker, water and if appropriate a buffer, and also a reducing agent, are heated in a gentle stream of nitrogen until the first polymer particles appear. Then, a mixture which has previously been rendered inert by blowing nitrogen through it of, in particular, styrene or acrylic acid, with or without crosslinker and with or without water as diluent is added in the course of from 0.2 to 10 hours. The styrene or the acrylic acid and the crosslinker can also be dissolved in a water-miscible solvent. This can be, for example, lower alcohols such as methanol, ethanol, isopropanol, n-propanol or tert-butanol. This procedure has the advantage that the popcorn polymerization takes only a relatively short time. The popcorn polymers can be isolated from the aqueous solution and purified.

The popcorn polymers are usually produced in a yield of from about 70 to >99% of the theoretical yield. They can also be isolated from the aqueous suspension by filtration or centrifugation with subsequent washing with water and drying in conventional dryers such as circulating-air or vacuum drying cabinets, paddle dryers or pneumatic dryers. The popcorn polymers are practically insoluble in water and all solvents and also swell therein only slightly.

The invention further relates to a process for filtering and/or stabilizing an aqueous liquid, which comprises using as filter aid or stabilizer a polymer containing

a) from 0.1 to 99% by weight of an N-vinyllactam or N-vinylamine

b) from 0 to 10% by weight of a bifunctional crosslinker component

c) from 0.1 to 50% by weight of at least one further monomer polymerizable by free-radicals

where the percentages by weight of the individual components are based on the total amount of the popcorn polymer and total 100%.

The process can be carried out in such a manner that in each case only filtration or stabilization of the aqueous medium takes place, or, in addition to filtration, simultaneous stabilization also takes place.

In the filtration, preferably, the technique of precoat filtration is used.

The invention also relates to the use of the inventive polymers as filter aids and/or stabilizer.

The term filtration is taken to mean a suspension (prefilt) consisting of a discontinuous phase, (dispersed substances) and a continuous phase (dispersion medium) flowing through a porous filter medium. In the course of this solid particles are deposited on the filter medium and the filtered liquid (filtrate) leaves the filter medium in a clear state. The external force acting to overcome the resistance to flow in this case is an applied pressure difference.

In the filtration operation, fundamentally, various mechanisms of solids deposition may be observed. Principally, this involves surface filtration or cake filtration, sheet filtration and screen filtration. Frequently, a combination of at least two operations is involved.

In the case of surface or cake filtration, what are termed precoat filters in various designs are used for beverage filtration (Kunze, Wolfgang, Technologie Brauer und Mälzer [Brewing and malting technology] 7^{th} Edition, 1994, p. 372). All precoat systems have in common the fact that the solids present in the liquid to be filtered and also deliberately added solids (filter aid) are retained by a filter medium, a filter cake being built up. Flow must pass through this filter cake, as is the case for the filter medium, in the course of filtration. Filtration of this type is also termed precoat filtration.

The liquids to be filtered and/or stabilized include fruit juices or fermented beverages such as wine or beer. In particular, the inventive process is used for filtering and/or stabilizing beer.

The inventively prepared filter aids or stabilizers are distinguished by good wettability with water and constant flow rate with simultaneously good filtration action.

The examples hereinafter are intended to describe the invention in more detail, but without limiting it thereto.

### EXAMPLES

### Example 1 (VP:Sty) (50:50)

1800 g of distilled water, 148 g of N-vinylpyrrolidone, 1.8 g of N,N′-divinylethyleneurea and 0.125 g of sodium hydroxide were heated to 60° C. in a stirred apparatus with the introduction of a gentle stream of nitrogen. 0.272 g of sodium dithionite were then added. The mixture was heated to 75° C. and maintained at this temperature. White flakes formed after 30 minutes. Then, in the course of 4 hours, a solution of 2 g of divinylbenzene in 148 g of styrene was added evenly. The white flakes transformed into a polymer suspension which slowly became highly viscous. In the course of the 4 hours, the batch was diluted with a solution of 0.2 g of sodium dithionite in 1250 ml of distilled water. The batch was then further heated at 80° C. for 1 hour and then cooled. The experiment was purified by steam distillation and the viscous suspension was then filtered off and washed with water to remove impurities such as soluble polymer and monomer. Product weight 285 g, yield 95%.

### Example 2 (VP:Sty) (90:10)

1800 g of distilled water, 267 g of N-vinylpyrrolidone, 3 g of N,N′-divinylethyleneurea and 0.125 g of sodium hydroxide were heated in a stirred apparatus to 60° C. with the introduction of a gentle stream of nitrogen. 0.272 g of sodium dithionite was then added. The mixture was heated to 75° C. and maintained at this temperature. White flakes formed after 30 minutes. Then, in the course of 4 hours, a solution of 0.5 g of divinylbenzene in 29.5 g of styrene was added evenly. The white flakes transformed into a polymer suspension which slowly became highly viscous. In the course of the 4 hours, the batch was diluted with a solution of 0.2 g of sodium dithionite in 1250 ml of distilled water. The batch was then further heated for 1 hour at 80° C. and then cooled. The experiment was purified by steam distillation and the viscous suspension was filtered off and washed with water to remove impurities such as soluble polymer and monomer. Product weight 267 g, yield 89%.

### Example 3 (VP:Sty:AA) (5:35:60) (Comparative Example)

1800 g of distilled water, 15 g of N-vinylpyrrolidone, 0.3 g of N,N′-divinylethyleneurea and 0.125 g of sodium hydroxide were heated in a stirred apparatus to 60° C. with the introduction of a gentle stream of nitrogen. 0.272 g of sodium dithionite were then added. The mixture was heated to 75° C. and maintained at this temperature. White flakes formed after 30 minutes. Then, in the course of 4 hours, two solutions were added evenly: i) 3 g of divinylbenzene in 102 g of styrene; ii) 180 g of acrylic acid. The white flakes transformed into a polymer suspension which slowly became highly viscous. In the course of the 4 hours, the batch was diluted with a solution of 0.2 g of sodium dithionite in 1250 ml of distilled water. The batch was then further heated for 1 hour at 80° C. and then cooled. The experiment was purified by steam distillation and the viscous suspension was filtered off and washed with water to remove impurities such as soluble polymer and monomer. Product weight 267 g, yield 89%.

### Example 4 (VP:Sty:AA) (5:25:70) (Comparative Example)

1800 g of distilled water, 15 g of N-vinylpyrrolidone, 0.3 g of N,N′-divinylethyleneurea and 0.125 g of sodium hydroxide were heated in a stirred apparatus to 60° C. with introduction of a gentle stream of nitrogen. 0.272 g of sodium dithionite was then added. The mixture was heated to 75° C. and maintained at this temperature. White flakes formed after 30 minutes. Then, in the course of 4 hours, two solutions were added evenly: i) 2 g of divinylbenzene in 73 g of styrene; ii) 210 g of acrylic acid. The white flakes transformed into a polymer suspension which slowly became highly viscous. In the course of the 4 hours, the batch was diluted with a solution of 0.2 g of sodium dithionite in 1250 ml of distilled water. The batch was then further heated for 1 hour at 80° C. and then cooled. The experiment was purified by steam distillation and the viscous suspension was filtered off and washed with water to remove impurities such as soluble polymer and monomer. Product weight 255 g, yield 85%.

Comparative example Divergan F (BASF, Germany), insoluble highly crosslinked vinylpyrrolidone-based polymers.

Absorption of Tannins

| | | Tannins |
|---|---|---|
| Sample stabilization contact time 5 min | Amount | PVP/mg/I |
| Blank beer | 50 g/hl | 50.87 |
| Example 3 | 50 g/hl | 41.14 |
| Example 5 | 50 g/hl | 34.50 |
| Example 6 | 50 g/hl | 54.50 |
| Divergan F | 50 g/hl | 9.50 |

Catechin Reduction

| Sample stabilization | Amount | Catechin reduction |
|---|---|---|
| contact time 5 min | | (%) |
| Example 1 | 50 g/hl | 3.69 |
| Example 2 | 50 g/hl | 6.52 |
| Example 3 (Comparative) | 50 g/hl | 13.60 |
| Example 4 (Comparative) | 50 g/hl | 20.46 |

The stabilization tests described below were carried out on selected examples. For this, the following approach was followed in detail: Prior to the analyses, the beer was degassed by agitation (beer decarbonation). The speed of the magnetic stirrer must be chosen so that no atmospheric oxygen is incorporated into the beer.

Adsorption Capacity of PVPP

Weigh out from 20 to 100 mg PVPP (based on dry matter)

Add 200 ml of decarbonated beer

Contact time during agitation exactly 5 minutes

Filter off through a glass frit

Submit filtrate to tannin or anthocyanogen determination

Blank beer (blank value) in accordance with the above without addition of PVPP

Analytical Procedure

Method for Determination of Anthocyanogens

G. Harris, R. W. Ricketts: “Studies on non-biological haze . . . ”, J. Inst. Brew., Vol. 65, 331-333 (1959), MEBAK, Brautechn. Analysenmethoden [Analytical methods for brewing], Volume II, 3^{rd} Edition, 171-172 (1993), correction to method in accordance with MEBAK decision of Apr. 22, 1999.

The anthocyanogens are determined photometrically via the conversion to red anthocyanidins by hot hydrochloric acid.

Method for Determination of Tannins

Tannometer, from Pfeuffer (Haze Titration)

The tannin content of beer is determined by polyvinylpyrrolidone. Protein-like compounds accumulate tannins via H bonds. As a result of complexing, this forms a haze. In the tannometer the haze is measured as a function of the amount of PVP added. The result gives the tannin content in mg of PVP/1 of beer.

The adsorption capacity of PVPP [%] is calculated from the tannin values.

Filtration of a Standard Haze Solution

The filtration action is determined via the clarification of a standard haze solution, that is to say a formazin suspension of defined haze. These solutions are known to those skilled in the art for characterizing filter aids for the beverage industry. The test is carried out as precoat filtration. For this purpose the formazin suspension is filtered with the inventive filter aid in accordance with the EBC test at a precoat pressure of 4.4 bar. After in each case 5 l of flow, the haze was determined in accordance with the EBC method. The filtrate is counted as clear when the EBC value is less than 1. In addition, the flow rate and pressure drop at the filter body (pressure difference upstream and downstream of the filter body) were measured. The inventive polymers are distinguished by a low pressure drop and high filtration rates. During the entire test, both the precoat pressure and the filtration rate remained constant, which verifies the advantageous properties of the inventive filter aids (long service life).

Filtration Tests

| | | Pressure drop | | EBC- | EBC- | EBC- |
|---|---|---|---|---|---|---|
| | Flow rate | Δp(bar) | EBC- | haze | haze | haze |
| Polymer | (l/h) | after 15 l | haze (start) | (after 5 l) | (after 10 l) | (after 15 l) |
| Example 1 | 30 | 0.2 | 15.3 | 0.2 | 0.2 | 0.1 |
| Example 2 | 30 | 0.2 | 20 | 0.8 | 0.4 | 0.2 |

We claim:

1. An insoluble, only slightly swellable popcorn polymer containing
a) from 0.1 to 99% by weight of an N-vinyllactam or N-vinylamine
b) from 0 to 10% by weight of a bifunctional crosslinker component
c) from 0.1 to 50% by weight of at least one further monomer polymerizable by free-radicals
where the percentages by weight of the individual components are based on the total amount of the popcorn polymer and total 100%.

2. A popcorn polymer as claimed in claim 1, wherein the polymers set forth under (c) are selected from the group consisting of styrenes and/or at least one monounsaturated styrene derivative and/or acrylic acid and also esters and amides thereof.

3. A popcorn polymer as claimed in one of claims 1 or 2, wherein the n-vinyllactams or n-vinylamines set forth under (a) are selected from the group consisting of N-vinylpyrrolidone, N-vinylpiperidone, N-vinylcaprolactam, N-vinylimidazole, N-vinyl-2-methylimidazole, N-vinyl-4-methylimidazole or N-vinylformamide.

4. The use of popcorn polymers as claimed in one of claims 1 to 3 as filter aid and/or stabilizer for filtering or stabilizing aqueous liquids.

5. The use of popcorn polymers as claimed in claim 4, wherein, in addition to the filtration, stabilization of the aqueous liquid takes place at the same time.

6. A process for filtering and/or stabilizing an aqueous liquid, which comprises using a polymer as claimed in one of claims 1 to 3.

7. A process as claimed in claim 6, wherein, in the filtration, the precoat filtration method is used.

8. The process as claimed in either of claims 6 and 7, wherein the aqueous liquid is a liquid selected from the group consisting of fruit juice drinks or fermented drinks.

9. A process as claimed in one of claims 6 to 8, wherein the aqueous liquid is beer.

10. A filter aid comprising polymers as claimed in one of claims 1 to 3.

11. A stabilizer comprising polymers as claimed in one of claims 1 to 3.
